(19) United States
(12) Patent Application Publication
(10) Pub. No.: US 2002/0033592 A1
(43) Pub. Date: Mar. 21, 2002

(54) Airbag having hollow compartments within the bag

(76) Inventors: Rick Adkisson, Mesa, AZ (US); Robert Sands, Mesa, AZ (US)

Correspondence Address: Susan D. Reinecke, Mayer, Brown & Platt, P.O. Box 2828, Chicago, IL, 60690-2828, US

(21) Appl. No.: 09/992,226

(22) Filed: Nov. 19, 2001

Related U.S. Application Data
(62) Division of application No. 09/523,876, filed on Mar. 13, 2000.

(51) Int. Cl. B60R 21/16

(52) U.S. Cl. 280/743.1

(57) ABSTRACT

An improved airbag design has a defined gas pressure release area located in the perimeter or outer seam region of the airbag. The bag includes an extended area that protrudes from the perimeter seam or seal location. In this region, between the parallel portions of the seal or seam, there is no seal or seam present. The absence of the seal or seam in this region and the configuration of the seal or seam provides a controlled pressure release vent area. Once the vent region is opened, it allows pressurized gas from within the bag to vent at a given rate. Hollow core regions or cavities within an air bag form non-pressurized compartments located within the bag cavity that desirably decrease the volume of gas required to completely fill the bag. The presence of these compartments also decreases the time that it takes to fully pressurize the airbag in order to provide the desired cushioning effect. Furthermore, because there is a decreased volume of gas within the bag, it takes less time to deflate the bag after it has been deployed. This allows passengers who have been protected from injuries by the bag to more quickly exit a passenger compartment.

### BACKGROUND OF THE INVENTION

1. Field of the Invention

The present invention relates generally to the field of automatic inflatable airbags which protect occupants in a passenger compartment during collisions. More specifically, the present invention is directed to innovations in construction of pressure release mechanisms for inflatable air bags as well as an improved airbag design that decreases the volume of gas required to inflate an air bag.

2. Description of the Related Art

Airbags have been used extensively now for several years in the automobile industry, and more recently, they have been suggested for use in aircraft. Currently, however, there is no know airbag design which provides a controlled pressure release area within the airbag material for relieving pressure from the airbag after the bag has been filled with gas.

It is well known that air bags provide protection for occupants in a passenger compartment by using rapidly expanding gas to fill a cavity in order to provide protection for occupants in a passenger compartment during a collision or crash. However, once an air bag has been deployed, it becomes a cumbersome object and can form a barrier that prevents or limits the ability of a passenger to exit the passenger compartment after an accident. This may be especially true in aircraft where there is often limited space in the passenger compartment and there are limited options for exiting the plane.

The elimination of gas from a deployed airbag in a reasonably short period of time after deployment of the bag therefore may be very important because a deployed airbag that has not been relieved of its internal pressure may potentially prevent a person from exiting the passenger compartment in which the airbag has been deployed. Currently, there is no available system that provides a pressure relief mechanism that is manufactured into or within the material of the air bag.

Accordingly there remains a need for an improved airbag construction having a novel pressure release mechanism which will aid in allowing a person to exit a vehicle once the airbag has been deployed and utilized for its intended purpose.

Another shortcoming of existing airbags is that the entire volume of the bag must be filled with gas during deployment in order to provide the desired effect. However, the inventors of the present application have discovered that it is not necessary to fill the entire volume of an air bag in order to provide the necessary or desired cushioning effect during an impact event.

Furthermore, the use of an airbag which must be completely filled in order to be fully deployed and useful has two undesirable characteristics. First, the volume of gas that must be forced into the bag is greater for a bag that must be completely filled for a given size in contrast with one that has pockets or cavities located within the bag that are not filled with pressurized gas. Furthermore, it takes longer for a bag of a given size to fully inflate when no cavities are present within the bag.

The inventors of the present invention have overcome these shortcomings through the design of a bag which includes compartments located within the bag that are not pressurized. The design of an airbag having non-pressurized compartments located within the primary bag cavity desirably decreases the volume of gas required to completely fill the bag. The presence of these compartments also decreases the time that it takes to fully pressurize the airbag in order to provide the desired cushioning effect.

These and other objects and advantages of the present invention will be apparent from the following summary and detailed description of the presently preferred embodiments.

### SUMMARY OF THE INVENTION

In accordance with the present invention, the improved airbag design has a defined gas pressure release area located in the perimeter or outer seam region of the airbag. Specifically, a portion on the perimeter of the bag seal includes an extended area that protrudes from the perimeter seam or seal location. In this region, the bag seal or seam approaching the center of this area from two opposite directions extends outward from the side of the bag such that the seal or seams each turn in the same direction away from a convergence point and become parallel with one another to define a controlled pressure release vent area therebetween. In this region between the parallel portions of the seal or seam, there is no seal or seam present.

The absence of the seal or seam in this region and the configuration of the seal or seam provides a controlled pressure release vent area. The controlled pressure release vent area defined by the stitching or seam pattern described above allows the bag to pressurize to a certain amount statically while the gas expands into the bag. The force due to stitching or seam adjacent this region keeps the vent area closed as an occupant loads the bag during deceleration as a result of an impact event. During deceleration, the bag pressure increases and overcomes the force that keeps the vent closed. This force is provided by the adjacent stitching or seam. Once the vent region is opened, it allows pressurized gas from within the bag to vent at a given rate.

The seal or seam is desirably formed by mechanical stitching or ultrasonic welding and the gap between the parallel outer stitching of the bag in the controlled pressure release area is desirably two to three inches wide and preferably protrudes out from the perimeter of the bag. Those skilled in the art will appreciate that variation of the width of this orifice and the length of the extended area will alter the dynamics of this pressure relief area. Specifically, by altering these dimensions, it is possible to affect a maximum attainable pressure for the bag or a pressure at which a bag will begin to exhaust gas through this valve. A bag having this geometry for the seam or seal may be comprised of any conventional airbag material. Those skilled in the art will appreciate that most bag materials will be suitable for use with the present invention. This controlled pressure release vent area automatically reduces the size of the bag after an impact event thereby allowing passengers to more readily exit from the passenger compartment.

Another further innovation of the present invention is the inclusion of hollow core regions within an air bag. It has been found that these hollow core regions provides numerous advantages over air bags that do not have these characteristics. The design of an airbag having non-pressurized compartments located within the bag cavity desirably decreases the volume of gas required to completely fill the bag. Accordingly the gas generators that are used for filling the bag may be physically smaller. The presence of these compartments also decreases the time that it takes to fully pressurize the airbag in order to provide the desired cushioning effect. Furthermore, because there is a decreased volume of gas within the bag, it takes less time to deflate the bag after it has been deployed. This allows passengers who have been protected from injuries by the bag to more quickly exit a passenger compartment.

In accordance with the present invention, hollow core members are inserted within the volume of the airbag that limit the amount of gas that is required to inflate the airbag. Furthermore, for a given volume of an airbag, the presence of these hollow cores provides for a more rapid deployment of the airbag during an impact event. In order to reduce the volume in an airbag so that less gas in needed to pressurize it, hollow cores or holes have been added. These cores or holes may be attached and sealed between the front and back panels of the bag. The holes or cavities can be essentially any size or shape to facilitate ease of manufacture and can be employed with virtually any size bag. The reduction in volume helps reduce the size and weight of the gas generators to deploy the bag and also decreases the amount of time needed for deployment.

### BRIEF DESCRIPTION OF THE DRAWINGS

FIG. 1 illustrates a controlled pressure release vent in accordance with the present invention;

FIG. 2 illustrates an air bag having a plurality of cavities located within the body of the bag;

FIG. 3 is a side view illustration of the air bag disclosed in FIG. 2.

### DETAILED DESCRIPTION OF THE PREFERRED EMBODIMENT

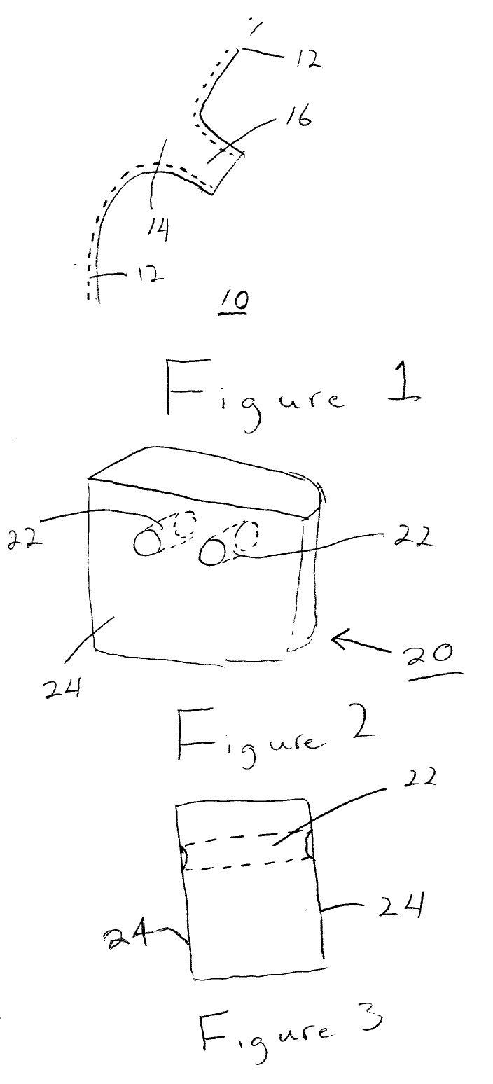

An exemplary embodiment of the present invention is shown generally at 10 in FIG. 1. As shown in FIG. 1, the airbag of the present invention includes a seam or seal region 12 preferably located in the outer perimeter of the airbag. The seam or seal region 12 may be formed of any conventional design and may be comprised of mechanical stitching or ultrasonic welding or any other known sealing technique that is known by those skilled in the art.

The improved airbag design has a defined gas pressure release vent area 14 located in the perimeter or outer seam region of the airbag. Specifically, a portion on the perimeter of the bag seal or seam 12 includes an extended area 16 that protrudes from the perimeter seam or seal 12. In this region, the bag seal or seam approaching the center of this area from two opposite directions extends outward from the side of the bag such that the seal or seams each turn in the same direction away from a convergence point and become parallel with one another to define a controlled pressure release vent area therebetween. In this region between the parallel portions of the seal or seam, there is no seal or seam present.

The absence of the seal or seam in this region 16 and the configuration of the seal or seam provides the controlled pressure release vent area. The controlled pressure release vent area defined by the stitching or seam pattern described above allows the bag to pressurize to a certain amount statically while the gas expands into the bag. The force due to stitching or seam adjacent this region keeps the vent area closed as an occupant loads the bag during deceleration as a result of an impact event. During deceleration, the bag pressure increases and overcomes the force that keeps the vent closed provided by the adjacent stitching or seam thereby allowing gas to vent at a given rate.

The stitching or seam 12 is desirably formed by mechanical stitching or ultrasonic welding and the gap between the parallel outer stitching of the bag in the controlled pressure release area 16 is desirably two to three inches in width between the the parallel seam or seal members and it is preferred that this region extend outward from the bag perimeter. Those skilled in the art will recognize that the airbag of the present invention may employ most any material used by those skilled in the art for the manufacture of air bags. This controlled pressure release vent area automatically reduces the size of the bag after an impact event thereby allowing passengers to more readily exit from the passenger compartment.

FIG. 2 illustrates an exemplary embodiment of a further innovation of the present invention which is shown generally at 20. Hollow core regions or cavities 22 are formed within an air bag and are preferably located between opposed sides of the bag 24. It has been found that these hollow core regions provide numerous advantages over air bags that do not have these structures. The design of an airbag having non-pressurized compartments or cavities located within the primary bag cavity desirably decreases the volume of gas required to completely fill the bag. Accordingly the gas generators that are used for filling the bag may be physically smaller. The presence of these compartments also decreases the time that it takes to fully pressurize the airbag in order to provide the desired cushioning effect. Furthermore, because there is a decreased volume of gas within the bag, it takes less time to deflate the bag after it has been deployed. This allows passengers who have been protected from injuries by the bag to more quickly exit a passenger compartment. Additionally, the fact that the entire bag geometry is not filled with pressurized gas does not decrease the ability of the bag to safely decelerate a person during an impact or collision.

As illustrated in FIG. 2, hollow core members 22 are inserted within the volume of the airbag that limit the amount of gas that is required to inflate the airbag. For a given volume of an airbag, the presence of one or more of these hollow cores 22 provides for a more rapid deployment of the airbag during an impact event. In order to reduce the volume in an airbag so that less gas in needed to pressurize it, a plurality of sealed hollow cores 22 or holes have been added. These sealed cores or holes are desirably attached and sealed between opposite sides of the airbag. The sealed holes or cavities can be essentially any size or shape to facilitate ease of manufacture and can be employed with virtually any size bag. The exemplary hollow cores 22 are shown in their preferred form as hollow circular collumns, however, this is simply a matter of design choice. Rectangular shaped cavities or other non-standard geometric shapes will also provide the desired effect. Regardless of the shape of the cavities, the reduction in volume helps reduce the size and weight of the gas generators required to deploy the bag and also decreases the amount of time needed for deployment.

The material for forming the hollow regions 22 which are not filled with pressurized gas are preferably formed of the same material from which the bags are manufactured. This simplifies the manufacturing process and thus reduces costs.

What is claimed is:

1. An airbag comprising:
a seal or seam in a perimeter of an airbag;
said seal or seam including a portion extending from an edge of the bag wherein separate seal or seam portions extend parallel to one another and wherein no seal or seam is formed in a region between outer ends of the seal or seam members.

2. The airbag of claim 1, wherein the seal or seam is comprised of an ultrasonic weld.

3. The airbag of claim 1, wherein the seal or seam is comprised of a mechanical stitch.

4. The airbag of claim 1, further comprising a separate cavity formed within a gas receiving cavity.

5. The airbag of claim 4, wherein the cavity is comprised of a hollow collumn.

6. The airbag of claim 1, further comprising a bag side wall having a portion extending inwardly through a bag cavity that is attached to an opposite bag side wall.

7. An airbag comprising:
an internal cavity wall connected to an outer side wall of the airbag in a first region;
said internal cavity wall also connected to the outer side wall of the air bag in a secon region.

8. The airbag of claim 7, wherein the internal cavity wall is connected to the outer side wall in the first region by mechanical stitching.

9. The airbag of claim 7, wherein the internal cavity wall is connected to the outer side wall in the first region by ultrasonic welding.
